(19) United States
(12) Patent Application Publication
(10) Pub. No.: US 2017/0159735 A1
(43) Pub. Date: Jun. 8, 2017

(54) Adjusting Device for a Disc Brake, and Disc Brake with Such an Adjusting Device

(71) Applicant: KNORR-BREMSE Systeme fuer Nutzfahrzeuge GmbH, Muenchen (DE)

(72) Inventors: Abdelaziz RGUICHI, Olching (DE); Ralf WEBER, Muenchen (DE); Christian SCHEUFLER, Muenchen (DE)

(21) Appl. No.: 15/436,159

(22) Filed: Feb. 17, 2017

Related U.S. Application Data
(63) Continuation-in-part of application No. PCT/EP2015/066098, filed on Jul. 15, 2015.

(30) Foreign Application Priority Data
Aug. 21, 2014 (DE) 10 2014 111 956.8

(51) Int. Cl. F16D 65/56; F16D 41/067

(52) U.S. Cl. CPC F16D 65/568; F16D 41/067; F16D 2200/0056; F16D 2250/0007; F16D 2200/0021

(57) ABSTRACT

An adjusting device for a disc brake, in particular for utility vehicles, is provided. The adjusting device includes a freewheel having an inner ring and an outer ring. The inner ring and outer ring together with multiple rolling bearing balls form an axial ball bearing. The inner ring is rotatably supported relative to the outer ring by the rolling bearing balls. The freewheel further has a cage in which multiple clamping rollers are biased with compression springs and compression pieces, the cage being arranged between the inner ring and the outer ring in a radial direction relative to a through-bore passing through the inner and outer rings. The compression springs may be pretensioned by rotating the cage relative to the inner ring and then fixing the cage to on the inner ring with a locking device.

### CROSS REFERENCE TO RELATED APPLICATIONS

This application is a continuation of PCT International Application No. PCT/EP2015/066098, filed Jul. 15, 2015, which claims priority under 35 U.S.C. §119 from German Patent Application No. 10 2014 111 956.8, filed Aug. 21, 2014, the entire disclosures of which are herein expressly incorporated by reference.

### BACKGROUND AND SUMMARY OF THE INVENTION

The present invention relates to an adjusting device for a disk brake for vehicles, in particular for commercial vehicles. The invention also relates to a disk brake with such an adjusting device.

Vehicles and certain technical equipment often use friction brakes to convert kinetic energy. In this context, specifically in the passenger vehicle and commercial vehicle sector, disk brakes are preferred. With the typical design of a disk brake, said disk brake comprises a brake caliper together with an internal mechanism, generally consisting of two brake linings and a brake disk. In, for example, a commercial vehicle disk brake, the cylinder forces are introduced into the internal mechanism via a pneumatically actuated cylinder, intensified by an eccentric mechanism, for example with a pivoted brake lever, and transmitted to the brake linings and brake disk as an application force via threaded spindles, wherein the wear of the brake disk and brake linings is compensated for via the threaded spindles.

Since, in terms of construction, the brake linings are designed as wearing parts, they are generally softer than the brake disk, i.e., the linings undergo a change in the thickness of the lining over their time in use: they wear. The brake disk can also wear. This wear gives rise to the need for wear adjustment to compensate for the change due to wear, thus establishing a constant release clearance. A constant release clearance is required to keep the response times of the brake short, to ensure the freedom of movement of the brake disk and to maintain a reserve stroke for limiting load cases.

Disk brakes, in particular for commercial vehicles, are generally equipped with an adjusting device which acts on at least one adjusting spindle having a movement thread. The adjusting device keeps constant the disk-brake release clearance which increases due to wear of the brake linings and brake disk. For this purpose, the adjusting device has an interface with an actuator, for example an eccentric lever. For as long as the release clearance has a defined value, the adjusting device cannot drive the movement thread. In addition, the adjusting device has to have overload protection which acts in the event of a force-fitting connection between adjusting spindle and friction pairing since otherwise the adjusting device would be destroyed by the driving torque which continues to act.

Furthermore, the adjusting device requires a freewheel which, in the return stroke of the actuator, prevents the movement thread from being driven in the opposite direction and therefore the release clearance from being increased again. In order to realize this function, use is often made of a conventional industrial freewheel. Said freewheels have great mechanical precision which is produced by a high degree of accuracy with correspondingly small tolerances of the individual parts during the production thereof.

The mechanical precision of a conventional industrial freewheel has a disadvantageous effect on the cost structure of an adjusting device for a disk brake since the precision of a customary industrial freewheel is not absolutely necessary for the use in an adjusting device of a disk brake.

An example of a wear adjustment device is described by document German patent publication no. DE 10 2004 037 771 A1. In this case, a driving rotary motion, e.g., that of a torque limiting device, for example a freewheeling and overload clutch device with a ball ramp, is transmitted to an adjusting spindle of a pressure plunger via a continuously acting clutch (slipping clutch). In this case, the release clearance is adjusted continuously.

Such an adjusting device 100′ is shown in FIG. 12. It consists substantially of the following functional elements:
shaft 101 with an adjuster axis 102
bearing disk 103
axial bearing 104
collar bushing or spacer sleeve 105
engaging fork or drive ring 106
freewheeling and overload clutch device 107
clutch ring 108
conical clutch 109
sleeve cone 110
spring sleeve 111 with an outer profiling 112 for engagement with an adjusting spindle
pretensioning spring 113
star-shaped driver 115 with an outer profiling 114
drive pin 116

Reference is made to German patent publication no. DE 10 2004 037 711 A1 in respect of the description.

A pivoting movement is introduced by the pivoted brake lever into the engaging fork with the drive ring 106 and into the freewheeling and overload clutch device 107 of the adjusting device.

There is a continuous need in vehicle engineering to save weight and costs, e.g., during assembly and maintenance, while, at the same time, there should be a saving of energy, i.e., fuel.

Accordingly, it is the object of the invention to provide an adjusting device for a disk brake that can be produced more cost-effectively than in the prior art.

According to the invention, it is provided that the compression springs are pretensioned in the cage by rotation of the cage in relation to the inner ring and subsequent form-fitting fixing of the cage on the inner ring. The invention is therefore based on the concept of designing a freewheel for an adjusting device of a disk brake in such a manner that essential components of the freewheel can be produced with the largest possible tolerances and therefore cost-effectively, wherein component tolerances which occur are compensated for by the pretensioning of the compression springs in the cage by rotation of the cage in relation to the inner ring of the freewheel and subsequent fixing of the cage on the inner ring of the freewheel, since the clamping rollers of the freewheel are thereby pressed by the compression springs into the clamping wedges of the inner ring. Therefore the satisfactory functioning of the freewheel is ensured despite relatively large tolerances of the individual components of the freewheel.

In a preferred embodiment of the invention, the clamping angles of the clamping wedges are formed with an angle of between 2.6° and 4.2°. These relatively large tolerances have a cost-reducing and therefore advantageous effect. By the pretensioning of the compression springs of the freewheel, the satisfactory functioning of the freewheel can be ensured despite the large tolerances of the clamping angles.

In a preferred embodiment of the invention, the inner ring and the outer ring of the freewheel are each produced by a deformation method or a primary forming method which permits deformation or primary forming to a net geometry with sufficient tolerances. As a result, finishing machining of the inner ring and of the outer ring can be dispensed with, or the finishing machining of the inner ring and of the outer ring can be restricted to a minimum. The production costs of the inner ring and of the outer ring can thereby be advantageously reduced in relation to the prior art.

In a further embodiment of the invention, the cage of the freewheel is composed of a plurality of cage segments which are each produced from a plastics material. The injection molding die in which the cage segments are produced is thereby simplified in an advantageous manner and can therefore be realized more cost-effectively. This is particularly the case if the cage segments are designed in terms of construction in such a manner that the final geometry thereof is produced by a film hinge being bent over. As a result, the injection molding die in which the cage segments are produced is advantageously further simplified, and therefore the die can be constructed without slides and hence in a particularly cost-effective manner.

In a further embodiment of the invention, the cage of the freewheel is produced integrally as a flat component composed of a plastics material from which the final geometry of the cage is produced only during the mounting, by a plurality of film hinges being bent over and by snap connections being latched in place. As a result, the injection molding die in which the cage is produced is advantageously simplified, and therefore the die can be constructed without slides and therefore particularly cost-effectively.

The invention furthermore provides a disk brake with an adjusting device according to the invention, which can be produced cost-effectively and therefore advantageously by the adjusting device according to the invention.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 shows a sectional illustration of a freewheel of an adjusting device according to the an embodiment of invention;

FIG. 2 shows a three-dimensional exploded illustration of a freewheel of an adjusting device according FIG. 1;

FIG. 3 shows a three-dimensional enlargement of a detail of a cage of a freewheel of an adjusting device according to FIG. 1;

FIG. 4 shows a sectional illustration of another embodiment of a freewheel of an adjusting device according to the invention;

FIG. 5 shows a three-dimensional exploded illustration of a freewheel of an adjusting device according to FIG. 4;

FIG. 6 shows a three-dimensional enlargement of a detail of a cage of a freewheel of the adjusting device according to FIG. 4 in the mounted state of the cage;

FIG. 7 shows a three-dimensional enlargement of a detail of the cage of FIG. 6 when the cage is not mounted;

FIG. 8 shows a sectional illustration of a further embodiment of a freewheel of an adjusting device according to the invention;

FIG. 9 shows a three-dimensional exploded illustration of the freewheel of an adjusting device according to the invention according to FIG. 8;

FIG. 10 shows a three-dimensional enlargement of a detail of the cage of the freewheel of FIG. 8 when the cage is not mounted;

FIG. 11 shows a three-dimensional enlargement of a detail of the cage of the freewheel of FIG. 8 in the mounted state of the cage;

FIG. 12 shows a partial sectional illustration of an adjusting device according to the prior art; and

FIG. 13 shows a schematic illustration of a disk brake with an embodiment of an adjusting device according to the invention.

### DETAILED DESCRIPTION OF THE DRAWINGS

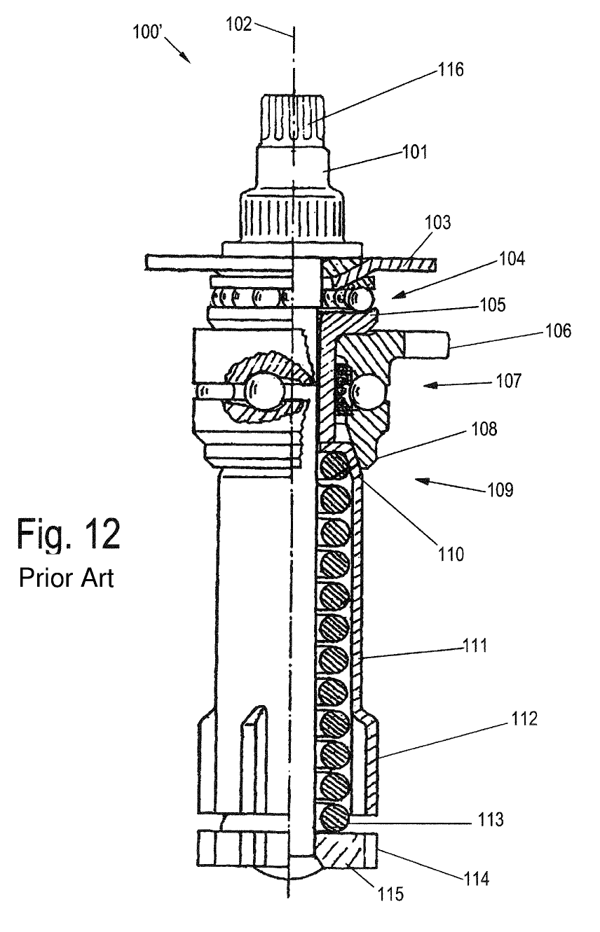

An adjusting device 100′ according to the prior art has already been described above in conjunction with FIG. 12 and will not be repeated here.

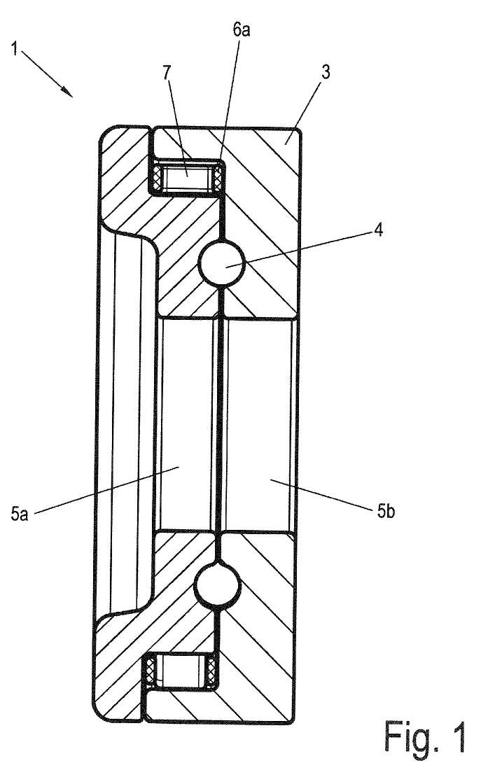

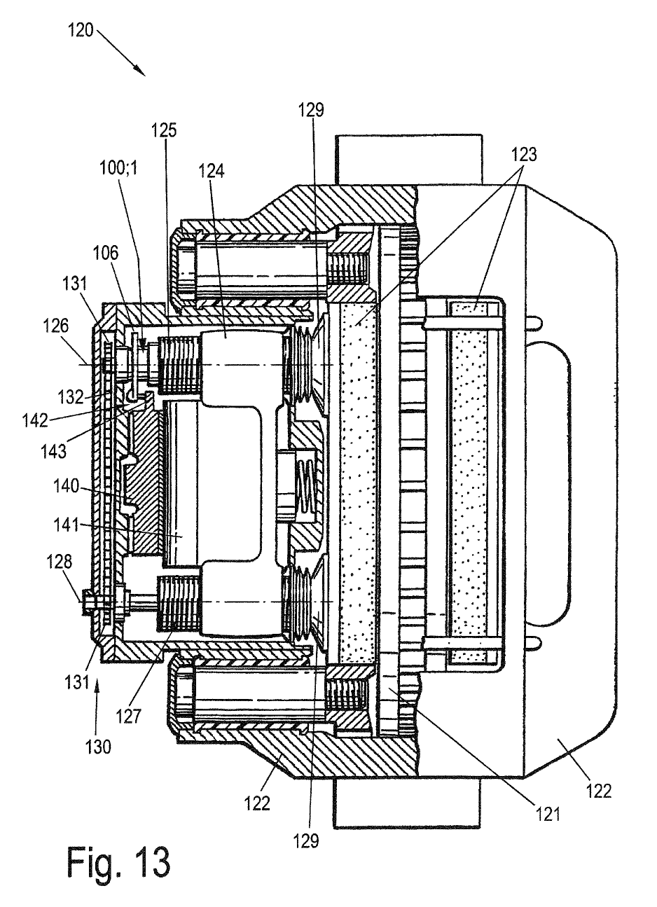

A clamping roller freewheel for the adjusting device 100 of a disk brake 120 is described below. The disk brake 120 is illustrated in FIG. 13 and is explained below. In the clamping roller freewheel shown in FIGS. 1-3, compression springs 12 press the clamping rollers 7 slightly between an inner ring 2 of the freewheel 1, said inner ring rotating together with the clamping rollers 7, and an outer ring 3 of the freewheel 1, and therefore the clamping rollers 7 become wedged, depending on the rotation thereof, in the receiving spaces or clamping wedges 9.

Since the receiving spaces of the clamping rollers 7 taper away from the compression springs 12, the transmitted torque is greater, the further the inner ring 2 is rotated in relation to the outer ring 3. By suitable selection of the setting or clamping angle of the clamping wedge 9, the embodiment is physically self-locking even in the presence of the best lubrication. For this purpose, the setting or clamping angle of the clamping wedge 9 has to be selected in such a manner that it is smaller than or equal to the arctangent of the coefficient of sliding friction μ which arises between the clamping roller 7 and the outer ring 3.

If the tapering or clamping angle is selected to be greater than arctan (μ), the freewheel 1 slips and is unreliable.

If the direction of rotation is reversed or if the outer rotational speed is greater than the inner rotational speed, the clamping rollers 7 roll in the direction of the compression spring 12 and the clamping is therefore neutralized.

For the adjusting device 100 of a disk brake 120 for commercial vehicles, the functioning of a freewheel 1 is required so that, in the return stroke of the adjusting device 100, an actuator of the adjusting device 100 does not rotate an adjusting spindle back, and therefore the release clearance of the disk brake is maintained at a defined value.

In the forward stroke of the adjusting device 100, the force-fitting connection of the freewheel 1 is required in order to ensure that the adjusting spindle is driven. It merely has to be ensured here that the torque which the freewheel 1 transmits is sufficient such that the freewheel 1 does not slip. Since the response torque of the overload protection and therefore of the freewheel 1 can be precisely defined, it is possible that the functional dimensions of the components of the freewheel 1 can move within relatively large tolerances without a satisfactory functioning of the freewheel 1 being lost.

When such a freewheel 1 is designed for an adjusting device 100 of a disk brake 120, a minimum coefficient of friction of μ=0.08 should be maintained, which permits a tapering or clamping angle of the clamping wedges 9 of approx. 2.6° to approx. 4.2°. Since the minimum clamping torque to be transmitted is also reached when all of the clamping wedges 9 of the freewheel 1 do not exceed the maximum clamping angle of 4.2°, it merely has to be ensured that a clamping angle of 2.6° to 4.2° is maintained per clamping wedge 9 of the freewheel 1. In the event of small angular values of the clamping angle, it merely has to be ensured that the Hertzian stress which is not to be exceeded for the expected service life of the freewheel 1 is maintained.

FIG. 1 illustrates an inventive freewheel 1 of an adjusting device 100 (not illustrated in detail here, but easily conceivable in conjunction with FIG. 12) of a disk brake 120 (see FIG. 13), in particular for commercial vehicles. The freewheel 1 has an inner ring 2 and an outer ring 3. The inner ring 2 and the outer ring 3 of the freewheel 1 together with a plurality of rolling bearing balls 4 form an axial ball bearing by which the inner ring 2 of the freewheel 1 is mounted rotatably in relation to the outer ring 3 of the freewheel 1. Furthermore, the freewheel 1 has a through bore 5a, 5b which in each case passes through the inner ring 2 and the outer ring 3. The freewheel 1 furthermore has a cage 6a in which a plurality of clamping rollers 7 are held. The cage 6a is arranged between the inner ring 2 and the outer ring 3 in a radial direction with respect to the through bore 5a, 5b and is completely surrounded by the inner ring 2 and the outer ring 3.

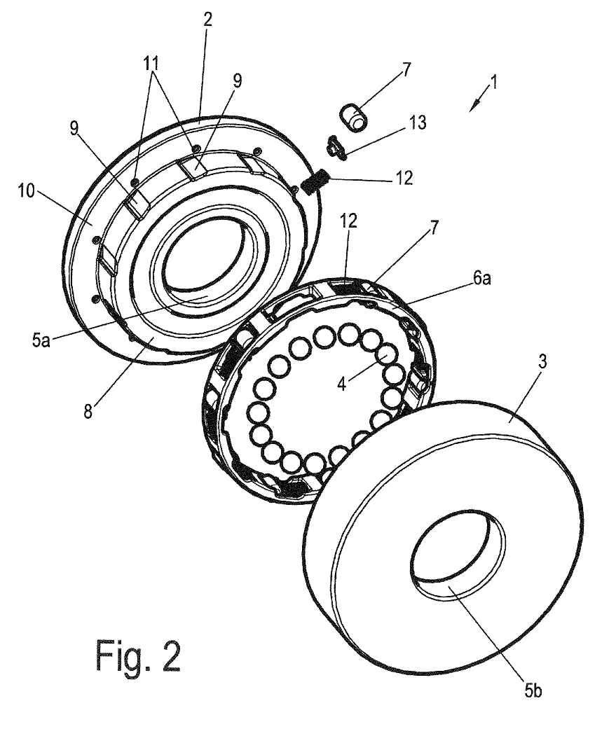

FIG. 2 shows the freewheel 1 from FIG. 1 in a three-dimensional exploded illustration.

The inner ring 2 has a step 8. The step 8 has a plurality of clamping wedges 9 on its circumference, said clamping wedges being arranged on the circumference of the step 8 at a regular angular pitch. The inner ring 2 furthermore has a shoulder region 10. The shoulder region 10 has bores 11 which run parallel to the through bore 5a and are arranged at a regular angular pitch in the circumferential direction. That side of the step 8 which faces away from the shoulder region has a channel in which the rolling bearing balls 4 are arranged in the mounted state of the freewheel 1 and, together with the inner ring 2 and the outer ring 3, form an axial ball bearing.

On account of the above-explained, relatively low accuracy requirements for the inner ring 2 and in particular for the clamping wedges 9, the inner ring 2 is preferably produced by a deformation method which permits a deformation to a net geometry with sufficient tolerances, as is the case, for example, in a cold extrusion method. In this case, the inner ring 2 is preferably produced from steel. Alternatively, however, the inner ring 2 can also be produced by a primary forming method which permits primary forming to a net geometry with sufficient tolerances, as is the case, for example, in a powder-metallurgical sintering method. In this case, the inner ring 2 is produced from a powder metal, preferably sintered steel. Alternatively, however, the inner ring 2 can advantageously also be produced from a technical ceramic material by a powder-metallurgical sintering method. It is essential to the invention in respect of the production of the inner ring 2 that a cost-intensive machining of a rough inner ring part in order to achieve correspondingly exacting component tolerances customary in the rolling bearing industry, in particular exacting tolerances of the clamping wedges 9, is dispensed with as far as possible. The outer ring 3 is produced analogously to the explanations in respect of the production of the inner ring 2.

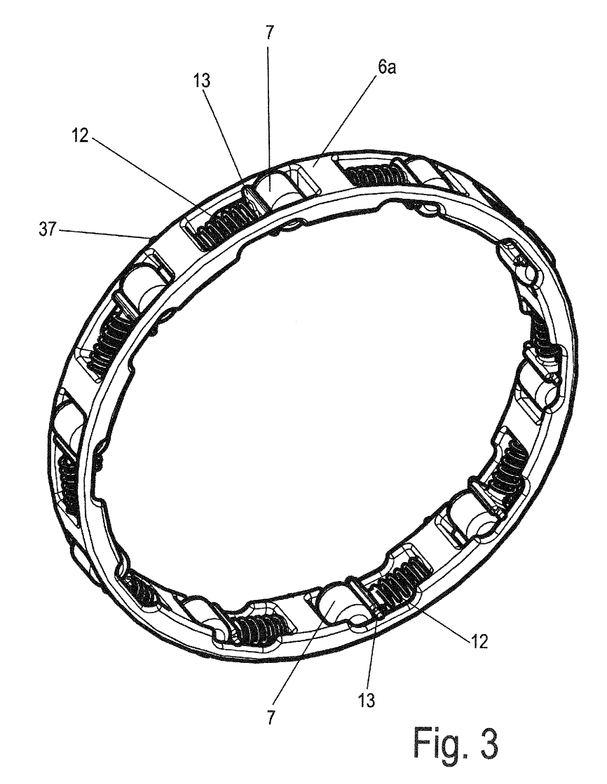

FIG. 2 likewise illustrates a compression spring 12. The compression spring 12 is designed here as a helical spring and in its mounted state is suspended on the cage 6a. In the mounted state, the compression spring 12 acts in the circumferential direction on a pressure piece 13 which, in turn, acts on the clamping roller 7 to press the clamping roller 7 into the clamping wedge 9. The compression spring 12, the pressure piece 13 and the clamping roller 7 therefore form a functional assembly of the freewheel 2. Said assembly is repeatedly arranged at a regular angular pitch on the circumference of the cage 6a and is held in each case by the cage 6a. In this embodiment of the invention, the cage 6a is equipped with the components 12, 13, 7 of the functional assembly in an advantageous manner by a cylindrical auxiliary device which is not illustrated here. A ready pre-assembled cage 6a is illustrated in FIG. 3.

The cage 6a is preferably produced from a plastics material in an injection molding method. The closed constructional design of said cage requires an injection molding die with a plurality of slides for this purpose, wherein the slides form geometry formations on the cage 6a that, owing to their arrangement or geometry, have to be removed from the die parallel to the parting plane of the die or spatially inclined with respect to the parting plane of the die.

The pressure piece 13 is illustrated here purely by way of example as a separate component which is produced from a plastics material in an injection molding method. Alternatively, the pressure piece 13 can also be realized by encapsulating one end of the compression spring 12 by injection molding. The pressure piece 13 can also be dispensed with if its function is integrated into the compression spring 12, for example as a bent wire lug.

Within the scope of the mounting of the freewheel, the compression springs 12 inserted together with the clamping rollers 7 and the pressure pieces 13 into the cage 6a are pretensioned. For the pretensioning operation, the cage 6a which is pre-assembled with the functional assemblies is placed onto the inner ring 2 of the freewheel 1 and rotated until the clamping rollers 7 latch into the clamping wedges 9 of the inner ring 2. The cage 6a is then rotated further and locked axially by the bores 11 in the shoulder region 10 of the inner ring 2 and a corresponding pin 37 which is integrally formed on the cage 6a.

The pretensioning of the compression springs 12 ensures that the clamping rollers 7 can reliably take on their function despite relatively large tolerances of the clamping angle in the clamping wedges 9. An essential structural criterion for the design of the compression springs 12 is an as large an effective spring travel as possible in order to securely press the respective clamping roller 7 into the corresponding clamping wedge 9 even if the clamping angles of the clamping wedges 7 are manufactured with relatively rough tolerances.

High accuracy requirements are not imposed on the cage 6a and the compression springs 12 since the spring force with which the clamping rollers 7 are pressed in the clamping wedges 9 should be very small. A small spring force means that the drag torque of the freewheel 1 in the freewheeling mode is very small. The functioning of the freewheel 1 is therefore reliably ensured even if the spring force varies in each case relatively greatly, which permits a relatively greatly different spring travel in the respective clamping wedge 9. This concept therefore permits a series of components 2, 3, 6a, 12, 13 of a freewheel 1 according to the invention to be designed with a wide tolerance range and therefore cost-effectively.

In order to avoid repetitions, only deviations or amendments and additions to the above-described embodiment of a freewheel 1 according to the invention according to FIG. 1 to FIG. 3 are described below.

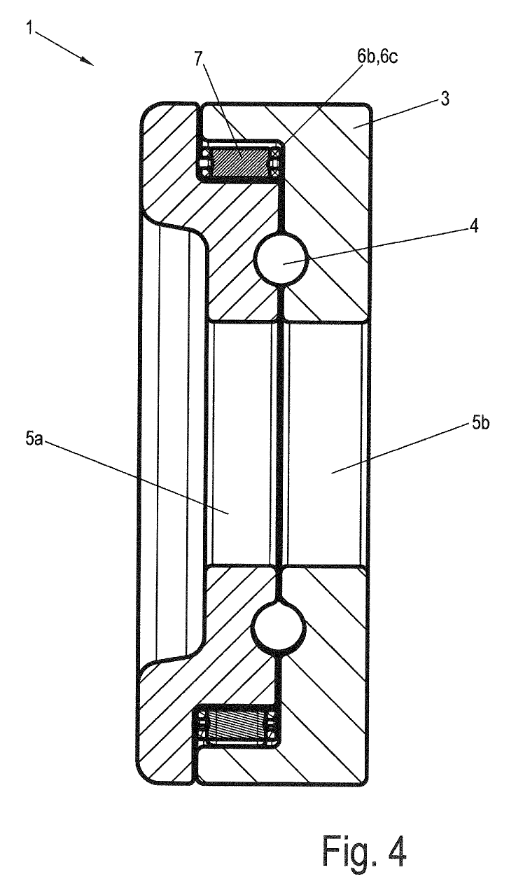

FIG. 4-6 illustrate an embodiment of the invention in which the cage 6b is produced in multi-sectional form as a chain consisting of a plurality of cage links 14a. Each cage link 14a accommodates a functional assembly of the freewheel 2, consisting of the compression spring 12, the pressure piece 13 and the clamping roller 7.

The cage links 14a pre-assembled in this manner are connected to one another via two plates 15a in each case which each have an eye 16a, and pins 17a, onto which the eye 16a is in each case suspended, to form the cage 6b. The plate 15a, with a continuous eye 16a, has a relatively low rigidity, and therefore tolerances can be simply and therefore advantageously bridged by elastic deformation or inherent stretching of the plate 15a. In this embodiment of the invention, the slide 13 is guided in the eye 16a via guide lugs 18 connected integrally to the slide 13.

The design of the cage 6b as a chain of cage links 14a permits simple mounting of the cage 6b for which an auxiliary device is not required since the individual cage links 14a are firstly each equipped with the compression spring 12, the pressure piece 13 and the clamping roller 7 and are subsequently braced together by the following cage link 14a and the plates 15a thereof.

In a cage link 14a, one pin 17a is designed to be longer than in the other cage links 14a, and therefore this pin 17a is used for the permanent pretensioning of the compression springs 12 with a form-fitting connection with respect to the inner ring 2 of the freewheel 1 via the bores 11 in the inner ring 2.

The cage links 14a of the cage 6b are preferably produced from a plastics material in an injection molding method. The structural design of the chain links 14a, in particular the design of the plate 15a with a continuous eye 16a, is such that an injection molding die with slides may be used to form geometry formations on the cage links 14a that, because of their arrangement or geometry, may be removed from the die parallel to the parting plane of the die or in a spatially inclined manner with respect to the parting plane of the die.

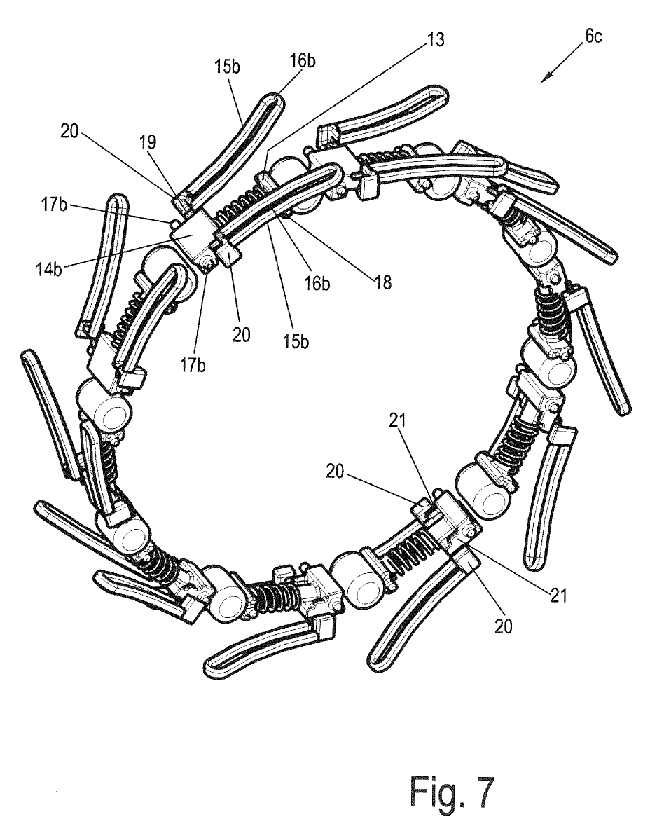

FIG. 7 illustrates a further embodiment of the invention, in which the cage 6c is designed in a multi-sectional manner as a chain consisting of a plurality of cage links 14b. Each cage link 14b accommodates a functional assembly of the freewheel 2, consisting of the compression spring 12, the pressure piece 13 and the clamping roller 7.

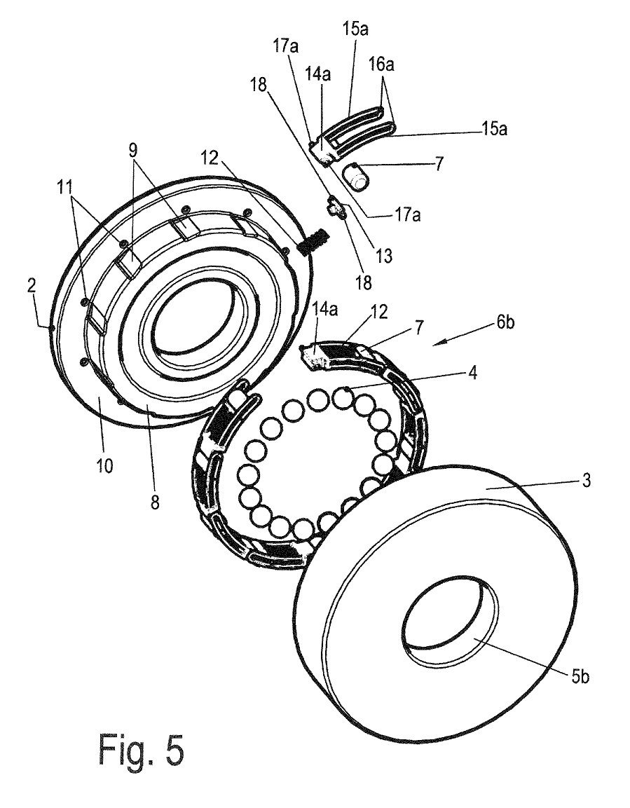

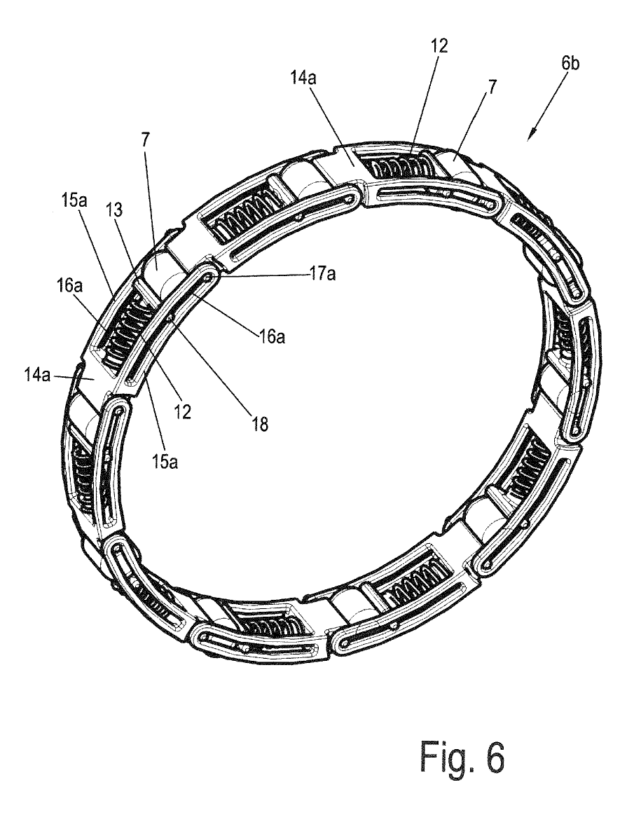

The cage links 14b pre-assembled in this manner are connected to one another via in each case two plates 15b which each have an eye 16b, and pins 17b which are each connected integrally to the cage links 14b and onto which the eye 16b is in each case suspended, to form the cage 6c. In a departure from the embodiment according to FIG. 5 and FIG. 6, the eyes 16b of the individual cage links 14b are each fitted onto the respective cage link 14b via film hinges 19. In this embodiment of the invention, the slide 13 is likewise guided in the eye 16a via guide lugs 18 connected integrally to the slide 13.

With the design of the plate 15b with a continuous eye 16b, the plate 15b has a relatively small rigidity, and therefore tolerances can be simply and therefore advantageously bridged by elastic deformation or intrinsic stretching of the plate 15b.

The design of the cage 6c as a chain of cage links 14b permits simple mounting of the cage 6c for which no auxiliary device is required since the individual cage links 14b are each firstly equipped with the compression spring 12, the pressure piece 13 and the clamping roller 7 and are subsequently braced together by the following cage link 14b and the plates 15b thereof. For this purpose, the respective plates 15b are first of all rotated by 90° via the respective film hinges 19. In the process, a plate lug 20 latches behind a web 21 which integrally onto the cage link 14c and thus locks the respective plate 15b in its final position. This functionality facilitates the mounting of the compression spring 12, the pressure piece 13 and the clamping roller 7 since first of all a plate 15b of the cage link 14c can be closed in order to provide guidance for the pressure piece 12 via the guide lug 18 which is inserted into the eye 16b of the plate 15b.

In a cage link 14b, one pin 17b is designed to be longer than in the other cage links 14b, and therefore this pin 17b is used for the permanent pretensioning of the compression springs 12 with a form-fitting connection with respect to the inner ring 2 of the freewheel 1 via the bores 11 of the inner ring 2.

The cage links 14b of the cage 6c are preferably produced from a plastics material in an injection molding method. With the structural design of the cage links 14b, in particular the design of the plate 15b which is connected integrally to the cage link 14b by a film hinge 19, an injection molding die for producing a cage link 14b is simplified since, as a result, all geometry formations on the cage links 14b can be removed from the die orthogonally to the parting plane of the die. Consequently, no slides are required on such an injection molding die.

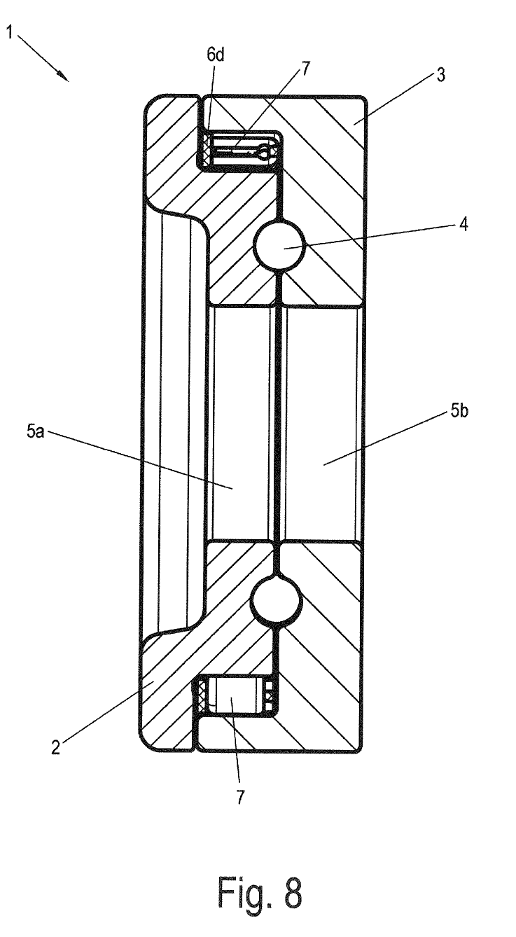

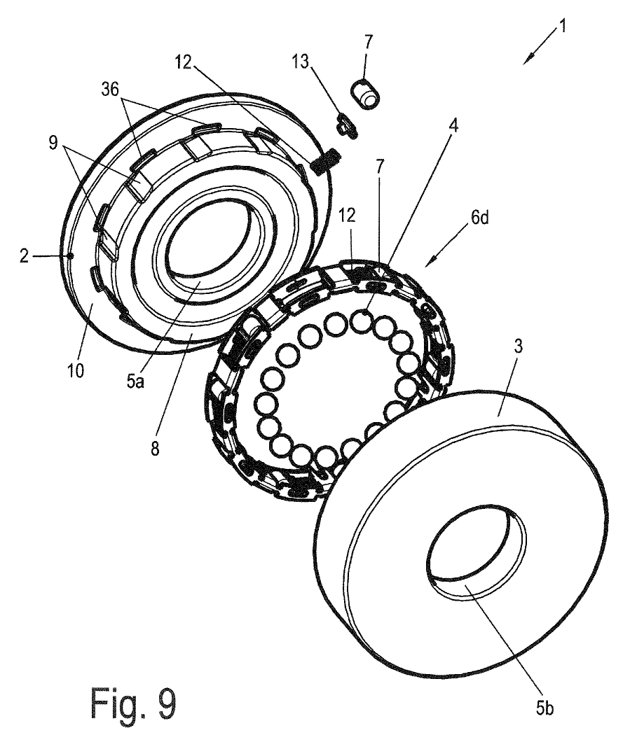

FIG. 8 to FIG. 11 illustrate a further embodiment of the invention in which the cage 6d—in a departure from the embodiments according to FIG. 4 to FIG. 7 and similarly to the embodiment according to FIG. 1 to FIG. 3—is of integral design.

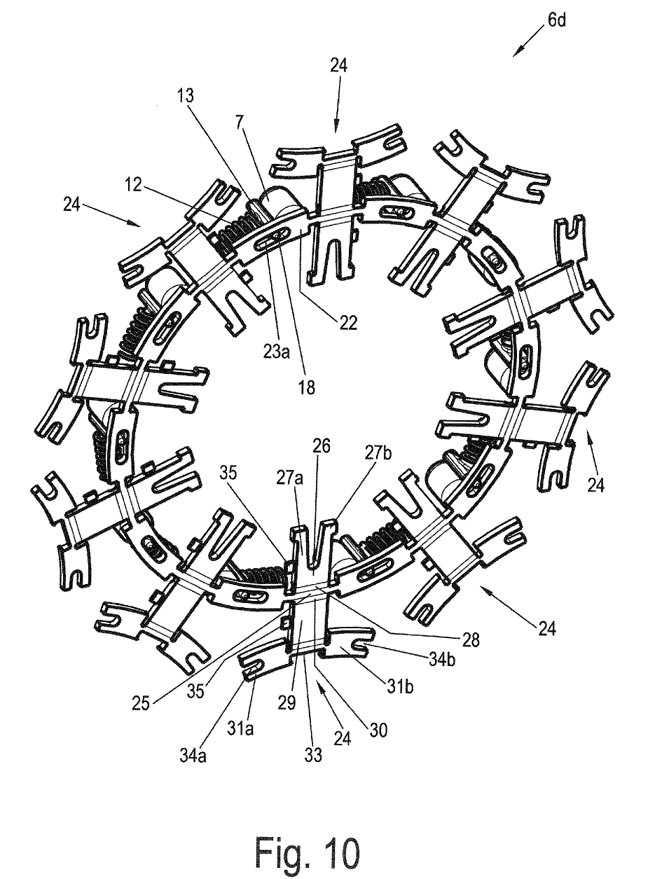

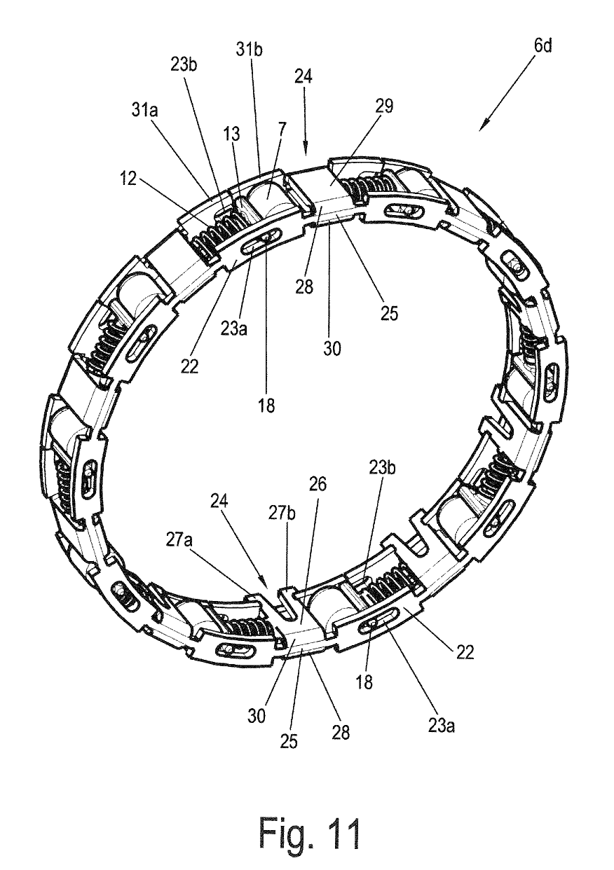

FIG. 10 illustrates the cage 6d in its unmounted state and FIG. 11 illustrates same in its mounted state. In a departure from the embodiment according to FIG. 1 to FIG. 3, the cage 6d in its unmounted state is designed as a flat component. The term “flat” in this case means that all functional geometrical configurations of the cage 6d are arranged in a plane—here the plane of the drawing—and only the wall thickness of the cage 6d extends in a plane orthogonal with respect thereto.

The cage 6d has a plurality of plate portions 22. This is illustrated in a readily identifiable manner in FIG. 10. The plate portions 22 are distributed on the circumference of the cage 6d at a regular angular pitch. Each plate portion 22 has an elongated hole 23a. The elongated hole 23a serves for guiding the pressure piece 13 which reaches with its guide lug 18 through the elongated hole 23a in the mounted state of the cage 6d. The respective plate portion 22 is in each case bounded by a locking portion 24, and therefore the locking portions 24 are likewise distributed on the circumference of the cage 6d at a regular angular pitch.

The locking portion 24 has a connecting web 25 via which the locking portion 24 is in each case connected integrally to the plate portion 22. The locking portion 24 furthermore has a snap hook portion 26 which forms two symmetrically opposite snap hooks 27a and 27b. In the unmounted state of the cage 6d, the snap hook portion 26 faces with its snap hooks 27a, 27b in each case radially in the direction of the center point of the circular cage 6d. The connecting web 25 and the snap hook portion 26 are connected by a film hinge 28.

The connecting web 25 is adjoined by a mating portion 29 which is likewise connected with a film hinge 30 to the connecting portion 25. The mating portion 29 is adjoined by two partial plate portions 31a and 31b which are connected to the mating portion 29 via a film hinge 32. The two partial plate portions 31a and 31b have a groove 33 in which the two snap hooks 27a and 27b latch in the mounted state of the cage 6d. The two partial plate portions 31a and 31b have a respective incision 34a, 34b. In the mounted state of the cage 6d, the two incisions 34a and 34b form an elongated hole 23b, also see FIG. 11 in this respect. The mating portion 29 and, with the latter, also the two partial plate portions 31a and 31b each face radially away from the center point of the circular cage 6d in the unmounted state of the cage. The snap hook portion 26 and the mating portion 29 each have a step 35 on which the compression spring 12 is supported in the mounted state of the cage 6d.

During the mounting of the cage 6d, first of all the mating portion 29 is bent by 90° at a locking portion 24 via the film hinge 30. The snap hook portion 26 is then bent by 90° via the film hinge 28. The compression spring 12 of the pressure piece 13 can then be mounted. The compression spring is supported on the two steps 35 while the pressure piece 13 is guided via its one guide lug 18 in the elongated hole 23a of the plate portion 22. The two partial plate portions 31a and 31b are then bent in turn by 90° via the film hinge 32, and therefore the two partial plate portions 31a, 31b now lie opposite the plate portion 22, and the other guide lug 18 of the pressure piece reaches through the incisions 34a and 34b of the partial plate portions 31a, 31b, the incisions forming the elongated hole 23b. The two snap hooks 27a and 27b of the snap hook portion 26 are subsequently latched into the groove 33 of the two partial plate portions 31a, 31b. The clamping roller 7 can be mounted when an adjacent locking portion 24 has been mounted in the above-described manner. As a result, the cage 6d is mounted successively or in sections.

Furthermore, the excess length of the snap hooks 27a, 27b in the axial direction of the cage 6b is used here to brace the cage 6b with a corresponding mating contour 36 introduced into the inner ring 2.

The cage 6d is preferably produced from a plastics material in an injection molding method. With the structural design of the cage 6d as a flat component, an injection molding die for producing a cage 6d is simplified since, as a result, all geometry formations of the cage 6d can be removed from the die orthogonally with respect to the parting plane of the die. Consequently, no slides are required on such an injection molding die.

FIG. 13 shows a schematic illustration of a disk brake 120, in particular for a commercial vehicle, having an adjusting device 100 (not illustrated here but easily conceivable in conjunction with FIG. 12) which acts on at least one adjusting spindle 125 having a movement thread. The adjusting device 100 keeps constant the release clearance of the disk brake 120, said release clearance increasing due to wear of the brake linings 123 and brake disk 121.

Furthermore, the adjusting device 100 has the freewheel 1 which, in the return stroke of the adjusting device 100, prevents a movement thread of the adjusting spindle 125 from being driven in the opposite direction and therefore the release clearance being again increased.

For the construction and function of a pneumatic disk brake according to FIG. 13, reference is made to the corresponding detailed description of German patent document no. DE 197 29 024 C1. The following components are indicated in FIG. 13: disk brake 120, brake disk 121, brake caliper 122, brake linings 123, crossmember 124, a first adjusting spindle 125 with a spindle axis 126, and a second adjusting spindle 127 with a second spindle axis 128, pressure pieces 129, a synchronizing unit 130 with sprockets 131, chain 132, and a pivoted lever 140 with an eccentric 141.

The pivoted lever 140 has a drive element 143 which interacts with an engaging fork of the drive ring 106 of the adjusting device 100 with the freewheel 1. The drive element 143 and the drive ring 106 form an adjuster drive 142 for the adjusting device 100. The adjusting device 100 is arranged here in the first adjusting spindle 125. The adjusting device 100 would also be suitable for a disk brake actuated by an electric motor.

The brake disk 121 is engaged over by the brake caliper 122 designed here as a floating caliper. A brake lining 123 is arranged on both sides of the brake disk 121. In this embodiment, the disk brake 120 is designed as a two-plunger brake with the two adjusting spindles 125 and 127.

The application-side brake lining 123 is connected to the adjusting spindles 125, 127 via the pressure pieces 129. The other, reaction-side brake lining 123 is secured in the brake caliper 122 on the other side of the brake disk 121. The adjusting spindles 125, 127 are each arranged rotatably in threads in the crossmember 124, which is also referred to as a bridge. The crossmember 124 and therefore the adjusting spindles 125 and 127 are actuable by an application device, here the pivoted lever 140.

The disk brake 120 can have different power drives. The pivoted lever 140 is actuated pneumatically, for example, here. The pivoted lever 140 is to the

The two adjusting spindles 125, 127 are coupled rotatably in a manner not described in more detail by a synchronizing unit 130 with sprockets 131 and a chain 132.

The foregoing disclosure has been set forth merely to illustrate the invention and is not intended to be limiting. For example, it is conceivable for the adjusting device 100 with the freewheel 1 also to be able to be used for single-plunger disk brakes and for disk brakes with more than two adjusting spindles. Since modifications of the disclosed embodiments incorporating the spirit and substance of the invention may occur to persons skilled in the art, the invention should be construed to include everything within the scope of the appended claims and equivalents thereof.

### LIST OF DESIGNATIONS

1 Freewheel
2 Inner ring
3 Outer ring
4 Rolling bearing ball
5a Through bore
5b Through bore
6a Cage
6b Cage
6c Cage
6d Cage
7 Clamping roller
8 Step
9 Clamping wedge
10 Shoulder region
11 Bore
12 Compression spring
13 Pressure piece
14a Cage link
14b Cage link
15a Plate
15b Plate
16a Eye
16b Eye
17a Pin
17b Pin
18 Guide lug
19 Film hinge
20 Plate lug
21 Web
22 Plate portion
23a Elongated hole
23b Elongated hole
24 Locking portion
25 Connecting web
26 Snap hook portion
27a Snap hook
27b Snap hook
28 Film hinge
29 Mating portion
30 Film hinge
31a Partial plate portion
31b Partial plate portion
32 Film hinge
33 Groove
34a Incision
34b Incision
35 Step
36 Mating contour
37 Pin
100, 100′ Adjusting device
101 Shaft
102 Adjuster axis
103 Bearing disk
104 Axial bearing
105 Spacer sleeve
106 Drive ring
107 Freewheeling and overload clutch device
108 Clutch ring
109 Conical clutch
110 Sleeve cone
111 Spring sleeve
112 Outer profiling
113 Pretensioning spring
114 Outer profiling
115 Star-shaped driver
116 Drive pin
120 Disk brake
121 Brake disk
122 Brake caliper
123 Brake linings
124 Crossmember
125 First adjusting spindle
126 First spindle axis
127 Second adjusting spindle
128 Second spindle axis
129 Pressure piece
130 Synchronizing unit
131 Sprockets
132 Chain
140 Pivoted lever
141 Eccentric
142 Adjuster drive
143 Drive element

What is claimed is:

1. An adjusting device for a disk brake, comprising:
a freewheel, the freewheel having an inner ring, an outer ring, and a plurality of rolling bearing balls arranged to form an axial ball bearing in which the inner ring is mounted rotatably in relation to the outer ring by said plurality of rolling bearing balls; the freewheel further having a through bore through the inner ring and the outer ring (3); and
a cage configured to receive a plurality of clamping rollers and respective compression springs and pressure pieces arranged to bias the plurality of clamping rollers in a circumferential direction,
wherein
the cage is arranged axially and radially between the inner ring and the outer ring, and radially outboard of the through bore,
the cage, inner ring and outer ring are configured to cooperate such that the compression springs are pretensioned in the cage by circumferential rotation of the cage relative to the inner ring, and
the inner ring is configured to receive a locking device arranged to fix the cage in a position which maintains the pretensioning of the compression springs.

2. The adjusting device as claimed in claim 1, wherein the locking device is a pin configured to be engage the inner ring and the cage.

3. The adjusting device as claimed in claim 1, wherein the locking device includes ends of snap hook pins configured to be engage a mating contour of the inner ring.

4. The adjusting device as claimed in claim 1, wherein the inner ring includes a step having an outer circumference containing a plurality of clamping wedges.

5. The adjusting device as claimed in claim 4, wherein in the mounted state of the freewheel the plurality of clamping rollers are arranged in respective ones of the plurality of clamping wedges.

6. The adjusting device as claimed in claim 5, wherein the plurality of clamping wedges have a clamping angle of between 2.6° and 4.2°.

7. The adjusting device as claimed claim 1, wherein the inner ring and the outer ring are at their respective net geometries following formation by a deformation method or a primary forming method.

8. The adjusting device as claimed in claim 7, wherein the inner ring and the outer ring are at their respective net geometries following formation by cold extrusion.

9. The adjusting device as claimed in claim 7, wherein a material of the inner ring and the outer ring is steel.

10. The adjusting device as claimed in claim 1, wherein a material of the inner ring and the outer ring is a sintered powder metal.

11. The adjusting device as claimed in claim 10, wherein the sintered powder metal is steel.

12. The adjusting device as claimed in claim 1, wherein the cage is an integral cage.

13. The adjusting device as claimed in claim 1, wherein the cage is a chain of a plurality of cage links.

14. The adjusting device as claimed in claim 13, wherein each of the plurality of cage links has two plates.

15. The adjusting device as claimed in claim 14, wherein the plates have respective eyes.

16. The adjusting device as claimed in claim 15, wherein each eye is connected to the respective cage link via a respective film hinge.

17. The adjusting device as claimed in claim 15, wherein the plurality of cage links each have at least one pin.

18. The adjusting device as claimed in claims 17, wherein the plurality of cage links are connected to one another by the eyes of the plurality of cage links being suspended on one of the at least one pin of an adjacent one of the plurality of cage links.

19. The adjusting device as claimed in claim 18, wherein a material of the plurality of cage links of the cage is an injection molded plastic.

20. The adjusting device as claimed in claim 1, wherein the cage has a plurality of plate portions distributed over the circumference of the cage.

21. The adjusting device as claimed in claim 20, wherein each of the plurality of plate portions has an elongated hole configured to receive a guide lug of a respective one of the pressure pieces.

22. The adjusting device as claimed in claim 21, wherein each of the plurality of plate portions is bounded by a respective one of a plurality of locking portions distributed around a circumference of the cage.

23. The adjusting device as claimed in claim 22, wherein each of the plurality of the locking portions is integrally connected to a respective one of the plurality of plate portions by a connecting web.

24. The adjusting device as claimed in claim 23, wherein each of the plurality of the locking portions has a snap hook portion with symmetrically opposite snap hooks which face in a direction of the center of the circular cage when the cage is in an unmounted state.

25. The adjusting device as claimed in claim 24, wherein each of the connecting webs and their respective snap hook portions are connected by a film hinge.

26. The adjusting device as claimed in claim 25, wherein a mating portion adjoins each of the connecting webs, and the mating portion is connected to the connecting portion with another film hinge such that the mating portion faces away from the center of the circular cage when the cage is in an unmounted state.

27. The adjusting device as claimed in claim 26, wherein each mating portion adjoins two partial plate portions connected to the mating portion via a further film hinge.

28. The adjusting device as claimed in claim 27, wherein the two partial plate portions have a groove in which the snap hooks are latched in the mounted state of the cage.

29. The adjusting device as claimed in claim 28, wherein the two partial plate portions each have an elongated hole in the mounted state of the cage.

30. The adjusting device as claimed in claim 29, wherein each of the snap hook portions and respective mating portions each have a step on which respective compression springs are supported in the mounted state of the cage.

31. The adjusting device as claimed in claim 28, wherein a material of the cage is an injection molded plastic formed as a flat component when removed from an injection molding die.

32. A disk brake, comprising an adjusting device as claimed in claim 1.
